(19) United States
(12) Patent Application Publication
(10) Pub. No.: US 2010/0265611 A1
(43) Pub. Date: Oct. 21, 2010

(54) CONTROLLER, DISK DRIVE HAVING THE CONTROLLER, AND DATA PROCESSING SYSTEM HAVING THE DISK DRIVE

(75) Inventor: Jin Wan JUN, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/761,997

(22) Filed: Apr. 16, 2010

(30) Foreign Application Priority Data
Apr. 20, 2009 (KR) 10-2009-0033969

(51) Int. Cl. G11B 5/09

(52) U.S. Cl. 360/46; G9B/5.033

(57) ABSTRACT

A controller for use in a disk drive includes a comparison signal generator for comparing a period of time when a write unsafe signal output from a pre-amplifier is activated with a reference period of time to generate a comparison signal; a write failure signal generator for generating a write failure signal according to a write gate signal and the comparison signal; and a logger for logging at least one of the period of time when a write unsafe signal output from a pre-amplifier is activated and the number of times of activations of the comparison signal.

### CROSS-REFERENCE TO RELATED APPLICATIONS

This application claims priority to Korean Patent Application No. 10-2009-0033969, filed on Apr. 20, 2009, in the Korean Intellectual Property Office, the disclosure of which is incorporated herein in its entirety by reference.

### BACKGROUND

Exemplary embodiments relate to a disk drive, and more particularly, to a controller capable of recording a generation log of a write unsafe signal, a disk drive including the controller, and a data processing system including the disk drive.

A pre-amplifier used in a hard disk drive (HDD) may transmit a write unsafe signal (WUS) to a hard disk controller when an abnormal situation occurs during a write operation.

The hard disk controller compares a period of time when the write unsafe signal WUS output from the pre-amplifier is activated with a reference period of time, and generates a write fault signal for stopping a write operation only if the period of time when the write unsafe signal WUS is activated is greater than the reference period of time. However, if the period of time when the write unsafe signal WUS is activated is smaller than the reference period of time, the hard disk controller controls the write operation to be continuously performed. Thus, unstable write data may be written to the HDD, and thus the reliability of read data may be degraded.

### SUMMARY

The exemplary embodiment provides a controller that can increase the reliability of data by recording a generation log of a write unsafe signal and performing a re-write operation according to the recorded log, a disk drive including the controller, and a data processing system including the disk drive.

According to an aspect of the exemplary embodiment, there is provided a controller for use in a disk drive, the controller including a comparison signal generator for comparing a period of time when a write unsafe signal output from a pre-amplifier is activated with a reference period of time to generate a comparison signal; a write failure signal generator for generating a write failure signal according to a write gate signal and the comparison signal; and a logger for logging, as log data, at least one of the period of time when a write unsafe signal output from a pre-amplifier is activated and the number of times of activations of the comparison signal. The controller may further include a memory for accumulatively storing the log data according to Logical Sector Numbers (LSNs).

According to another aspect of the exemplary embodiment, there is provided a disk drive including a disk; a head for writing a write data signal to the disk during a write operation; an access circuit for supplying the write data signal to the head and generating a write unsafe signal according to an abnormal signal output from the head; and a controller for generating a write failure signal for stopping the write operation performed by the head according to the write unsafe signal output from the access circuit.

The controller generates the write failure signal in response to a write gate signal and a comparison signal corresponding to a result of a comparison between a period of time when the write unsafe signal is activated and a reference period of time and logs, as log data, at least one of the period of time when the write unsafe signal is activated and the number of times of activations of the comparison signal.

The controller may control write data corresponding to the write data signal to be transmitted to the access circuit so that the write data signal is re-written to the disk according to the log data. The access circuit may include at least one of a pre-amplifier and a read/write channel.

The disk drive may further include a memory for accumulatively storing the log data according to LSNs.

The disk drive may further include at least one of a temperature detector for detecting an internal temperature of the disk drive and a voltage detector for detecting an operating voltage of the disk drive. During the write unsafe signal is active, the controller may log, as the log data, at least one of detected temperature by the temperature detector and detected voltage by the voltage detector.

According to another aspect of the exemplary embodiment, there is provided a data processing system including a disk drive; and a processor for controlling an operation of the disk drive. The disk drive includes a disk; a head for writing a write data signal corresponding to write data output from the processor to the disk during a write operation; an access circuit for supplying the write data signal to the head and generating a write unsafe signal according to an abnormal signal output from the head; and a controller for generating a write failure signal for stopping the write operation performed by the head according to the write unsafe signal output from the access circuit.

The controller may generate the write failure signal in response to a write gate signal and a comparison signal corresponding to a result of a comparison between a period of time when the write unsafe signal is activated and a reference period of time and log, as log data, at least one of the period of time when the write unsafe signal is activated and the number of times of activations of the comparison signal. The controller may control the write data to be transmitted to the access circuit so that the write data signal is re-written to the disk according to the log data.

### BRIEF DESCRIPTION OF THE DRAWINGS

Exemplary embodiments will be more clearly understood from the following detailed description taken in conjunction with the accompanying drawings in which:

FIG. 1 is a block diagram of a disk drive including a microcontroller, according to an exemplary embodiment;

FIG. 2 is a block diagram of the microcontroller illustrated in FIG. 1;

FIG. 3 is a waveform diagram of a write failure signal according to the type of a write unsafe signal;

FIG. 4 is a flowchart of an operation of the disk drive illustrated in FIG. 1; and

FIG. 5 is a block diagram of a data processing system including the disk drive illustrated in FIG. 1.

### DETAILED DESCRIPTION OF THE EMBODIMENTS

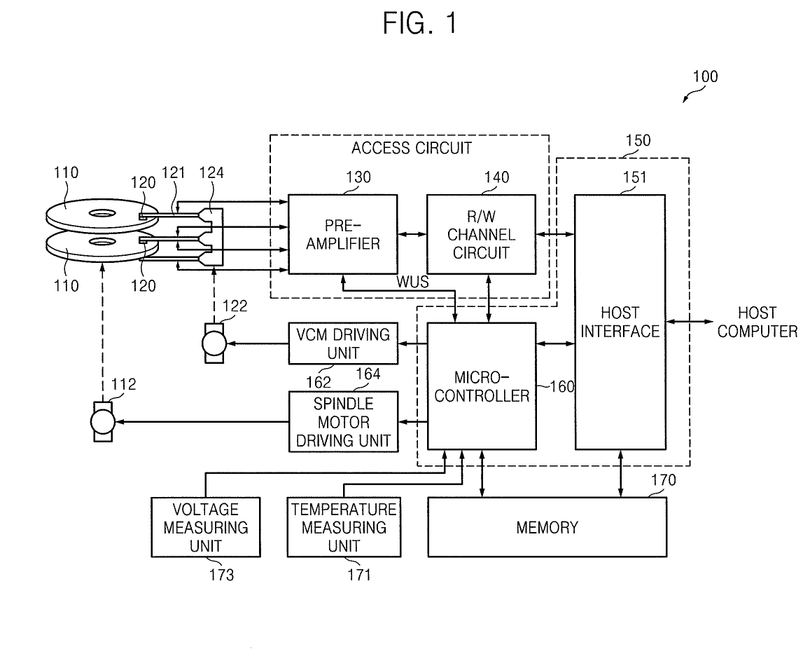

FIG. 1 is a block diagram of a disk drive 100 including a microcontroller 160, according to an exemplary embodiment. Referring to FIG. 1, the disk drive 100, which is a data storage device such as a hard disk drive (HDD), may include a plurality of data storage media 110 (for example, magnetic disks), a spindle motor 112, a plurality of magnetic heads 120, a voice coil motor (VCM) 122, an actuator 124, a pre-amplifier 130, a read/write (R/W) channel circuit 140, a host interface 151, the microcontroller 160, a VCM driving unit 162, a spindle motor driving unit 164, and a memory 170. The disk drive 100 may further include a temperature measuring unit 171, i.e., a temperature detector, or a voltage measuring unit 173, i.e., a voltage detector.

Each of the data storage media 110 may include a plurality of tracks which are concentric, and may be rotated by the spindle motor 112. Each of the magnetic heads 120 may be located over a corresponding storage medium from among the data storage media 110 to perform a read operation or a write operation under the control of the microcontroller 160. Each of the magnetic heads 120 may include a write head and a read head and may be installed on a slider (not shown).

Each of the magnetic heads 120 may be installed on each of a plurality of flexible suspension arms (not shown) installed on each of a plurality of rigid actuator arms 121 attached to an actuator 124. The rigid actuator arms 121 may move at least one corresponding magnetic head from among the magnetic heads 120 from or to over the tracks of the data storage media 110 under the control of the VCM 122, in order to perform a read operation or a write operation.

Each of the magnetic heads 120 may read a predetermined pattern from a predetermined area of each of the data storage media 110 and generate an analog read data signal.

When a data signal is read from each of the data storage media 110, the pre-amplifier 130 may receive and amplify an analog read data signal output from a corresponding magnetic head from among the magnetic heads 120 and output an amplified analog read data signal to the R/W channel circuit 140.

When a data signal is written to each of the data storage media 110, the pre-amplifier 130 may control a write data signal received from the R/W channel circuit 140 to be written to a corresponding data storage medium from among the data storage media 110 via a corresponding magnetic head from among the magnetic heads 120.

When an abnormal situation is detected during the write operation, the pre-amplifier 130 may output a write unsafe signal WUS to the microcontroller 160. The abnormal situation may include all of situations where the write data signal cannot be properly written to the data storage media 110, such as a situation in which a write voltage that is supplied when the write data signal is written to the data storage media 110 decreases, a situation in which the temperature of at least one of the magnetic heads 120 and the pre-amplifier 130 increases to be higher than a reference temperature, and a situation in which the resistor of the magnetic heads 120 is opened/shorted.

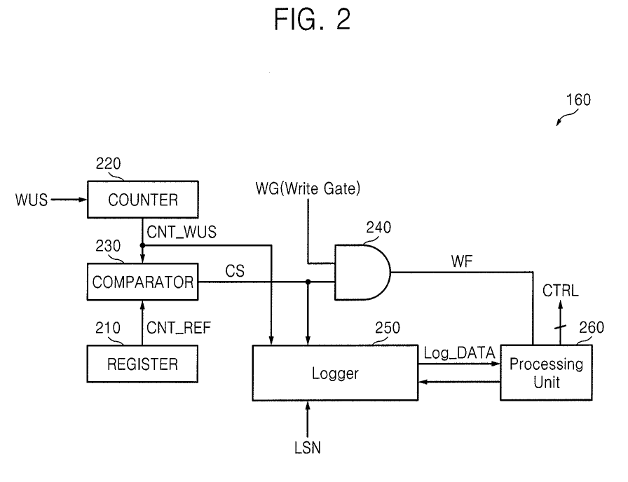

The microcontroller 160, which performs the function of a controller of the disk drive 100, may generate a write failure signal for stopping a write operation performed by the magnetic heads 120, according to the write unsafe signal WUS output from the pre-amplifier 130. Thus, when the write failure signal is activated, i.e., generated, a processing unit 260 (see FIG. 2) of the disk drive 100 may generate a plurality of control signals CTRL for stopping a write operation performed by the disk drive 100.

The microcontroller 160 may generate the write failure signal in response to a write gate signal and a comparison signal generated according to a result of a comparison between a period of time when the write unsafe signal WUS is activated, i.e., output or generated, and a reference period of time, and may record at least one of the group consisting of the period of time when the write unsafe signal WUS is activated and the number of times of activations of the comparison signal. A structure and a function of the microcontroller 160 will be described in greater detail with reference to FIGS. 2 through 4. Although the name of the microcontroller 160 is restricted to a controller, the microcontroller 160 may be any device as long as it can perform an operation according to an exemplary embodiment.

During a read operation, the R/W channel circuit 140 may detect a data pulse from the amplified analog read data signal output from the pre-amplifier 130, decode the data pulse, and output read data to the host interface 151. During a write operation, the R/W channel circuit 140 may encode write data output from the host interface 151 to output a write data signal to the pre-amplifier 130. In some exemplary embodiments, the read data or the write data may be temporarily stored in the memory 170.

Under the control of the microcontroller 160, the host interface 151 may transmit the write data which is to be written to the data storage media 110 of the disk drive 100 to the R/W channel circuit 140, or may transmit the read data read out of the data storage media 110 to a host computer.

The host interface 151 may also transmit a read command or a write command received from the host computer to the microcontroller 160 and transmit the read data or write data stored in the memory 170 to the host computer or the R/W channel circuit 140 in response to a plurality of control signals output from the microcontroller 160. Thus, the host interface 151 may interface a communication between the host computer and the R/W channel circuit 140, a communication between the microcontroller 160 and the host computer, a communication between the memory 170 and the host computer, a communication between the memory 170 and the microcontroller 160, or a communication between the memory 170 and the R/W channel circuit 140.

The microcontroller 160 may output the control signals to the R/W channel circuit 140 via the host interface 151 in response to the read command or the write command output from the host computer and may control the VCM driving unit 162 and the spindle motor driving unit 164 to control a track seek and/or track following on the basis of servo information received from the R/W channel circuit 140.

In some exemplary embodiments, the R/W channel circuit 140, the host interface 151, and the microcontroller 160 may perform the function of the controller of the disk drive 100 and may be formed into a single chip.

The memory 170 may temporarily store data communicated between the host computer, the microcontroller 160, and the R/W channel circuit 140, and store various programs to be performed in the microcontroller 160 and various set values.

The VCM driving unit 162 may generate a driving current for driving the VCM 122 in response to position control signals provided from the microcontroller 160. The position control signals may be signals for controlling the positions of the magnetic heads 120. The position control signals may be generated based on the servo information output from the R/W channel circuit 140.

The VCM 122 may move a corresponding magnetic head from among the magnetic heads 120 attached to the actuator 124 to over a corresponding data storage medium from among the data storage media 110 on the basis of a direction and/or level of the driving current received from the VCM driving unit 162. The spindle motor driving unit 164 may drive the spindle motor 112 according to the control signal generated by the microcontroller 160 to rotate the data storage media 110 at a predetermined rotation speed. In some exemplary embodiments, the VCM driving unit 162 and the spindle motor driving unit 164 may be formed into a signal chip.

The temperature measuring unit 171 may measure the internal temperature of a data storage device, namely, the HDD 100, and transmit a signal corresponding to a result of the measurement to the microcontroller 160. The voltage measuring unit 173 may measure the operating voltage of the data storage device 100 and transmit a signal corresponding to a result of the measurement to the microcontroller 160.

FIG. 2 is a block diagram of the microcontroller 160 illustrated in FIG. 1. Referring to FIGS. 1 and 2, the microcontroller 160 is capable of various functions including a data recovery operation in which a generation log of the write unsafe signal WUS is recorded and data recovery is performed based on log data Log_DATA corresponding to the recorded log, and a re-write operation, and may include a register 210, a counter 220, a comparator 230, a failure signal generator 240, a logger 250, and the processing unit 260.

The register 210 is an example of a memory for storing a reference count value CNT_REF that represents the reference period of time. Thus, the register 210 may be implemented into a volatile memory or a non-volatile memory. The reference count value CNT_REF may be programmed from an external source.

The counter 220 may count the period of time when the write unsafe signal WUS is activated, according to a clock signal, to output a WUS count value CNT_WUS. The counter 220 is an example of a measuring unit capable of measuring the period of time when the write unsafe signal WUS output from the pre-amplifier 130 is activated. As illustrated in FIG. 1, an access circuit capable of performing a write operation or a read operation under the control of the microcontroller 160 may include at least one of the pre-amplifier 130 and the R/W channel circuit 140.

The comparator 230 may compare the reference count value CNT_REF corresponding to the reference period of time with the WUS count value CNT_WUS corresponding to the period of time when the write unsafe signal WUS is activated, and output a comparison signal CS corresponding to a result of the comparison.

For example, if the WUS count value CNT_WUS is equal to or greater than the reference count value CNT_REF, a comparison signal CS having a first state (for example, a high level) may be output. If the WUS count value CNT_WUS is smaller than the reference count value CNT_REF, a comparison signal CS having a second state (for example, a low level) may be output. For example, each of the reference count value CNT_REF and the WUS count value CNT_WUS may be a digital signal expressed with a plurality of bits.

The failure signal generator 240 may generate a write failure signal WF in response to a write gate signal WG for instructing execution of a write operation and the comparison signal CS. For example, if the failure signal generator 240 is implemented into an AND gate, the failure signal generator 240 may generate the write failure signal WF having the first state in response to the comparison signal CS having the first state and the write gate signal WG having the first state. Thus, when the write failure signal WF having the first state is generated, the microcontroller 160 may stop the write operation according to the control signals CTRL output from the processing unit 260.

The logger 250 may record, as the log data Log_DATA, at least one of the WUS count value CNT_WUS and the number of times of activations of the comparison signal CS in a memory (not shown). In some embodiments, the logger 250 may accumulatively record at least one of the WUS count value CNT_WUS and the number of times of activations of the comparison signal CS in the memory according to Logical Sector Numbers (LSNs).

The memory may be installed within the logger 250 or in a specific region of the microcontroller 160. Alternatively, the memory may be implemented into a part of the memory 170.

The processing unit 260 may transmit to the logger 250 a command for reading the log data Log_DATA including at least one of the WUS count value CNT_WUS and the number of times of activations of the comparison signal CS, and may transmit the control signals CTRL for controlling a write operation, a read operation, or a re-write operation of the disk drive 100 to at least one of the pre-amplifier 130, the R/W channel circuit 140, the host interface 151, the VCM driving unit 162, and the spindle motor driving unit 164, according to the log data Log_DATA output from the logger 250.

The log data Log_DATA may include at least one of the WUS count value CNT_WUS, the number of times of activations of the comparison signal CS, a temperature measured by the temperature measuring unit 171 when the write unsafe signal WUS is activated, and a voltage measured by the voltage measuring unit 173 when the write unsafe signal WUS is activated. Thus, the processing unit 260 may monitor an operational status of the disk drive 100 on the basis of the log data Log_DATA.

The processing unit 260 may determine based on the log data Log_DATA whether the status of the disk drive 100 is abnormal, and may hold or stop an operation of the disk drive 100 according to a result of the determination. In some cases, the result of the determination may be transmitted to a host computer (see FIG. 1) via the host interface 151 of FIG. 1.

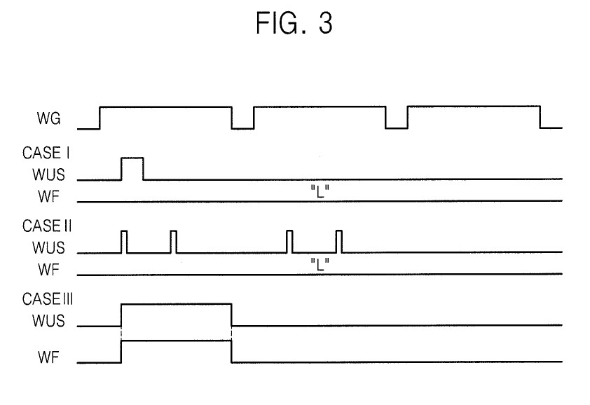

FIG. 3 is a waveform diagram of the write failure signal WF according to the write unsafe signal WUS. Referring to FIGS. 1 through 3, in case I where the WUS count value CNT_WUS is smaller than the reference count value CNT_REF, the comparator 230 outputs the comparison signal CS having the second state, and thus the failure signal generator 240 outputs the write failure signal WF having the second state. Thus, a write operation may be successfully performed under the control of the microcontroller 160. However, in the case I, while the write unsafe signal WUS is active, actual write data may not be written to the data storage media 110, or write data including noise may be written to the data storage media 110.

In case I, the write data including noise may be recovered by an error correction code, and thus the microcontroller 160 may not perform a re-write operation in order to prevent degradation of the performance of the disk drive 100.

In case II where the write unsafe signal WUS is generated several times for each sector, since the WUS count value CNT_WUS is smaller than the reference count value CNT_REF, each of the comparator 230 and the failure signal generator 240 outputs the write failure signal WF having the second state. Thus, the write operation may be successfully performed under the control of the microcontroller 160. However, in the case II, in every period while the write unsafe signal WUS is active, actual write data may not be written to the data storage media 110, or write data including noise may be written to the data storage media 110. In the case II, the write data including noise may not be recovered by an error correction code. In this case, the logger 250 may record the fact that the write unsafe signal WUS was activated twice per each sector.

In the case I or II, even when the write failure signal WF is not generated, a problem may exist in write data recovery. Thus, since the logger 250 of the microcontroller 160 may accumulatively record at least one of the WUS count value CNT_WUS and the number of times of activations of the comparison signal CS in the memory according to LSNs, the microcontroller 160 may perform a re-write operation after the write operation is properly completed according to data recorded in the logger 250.

Therefore, the microcontroller 160 may analyze an LSN having the write unsafe signal WUS and re-write write data to a sector corresponding to the analyzed LSN according to the data recorded in the logger 250, thereby increasing the reliability of the write data.

In case III where the WUS count value CNT_WUS is greater than the reference count value CNT_REF, each of the comparator 230 and the failure signal generator 240 outputs the write failure signal WF having the first state. Thus, the write operation is stopped under the control of the microcontroller 160. Thereafter, the microcontroller 160 may perform a re-write operation.

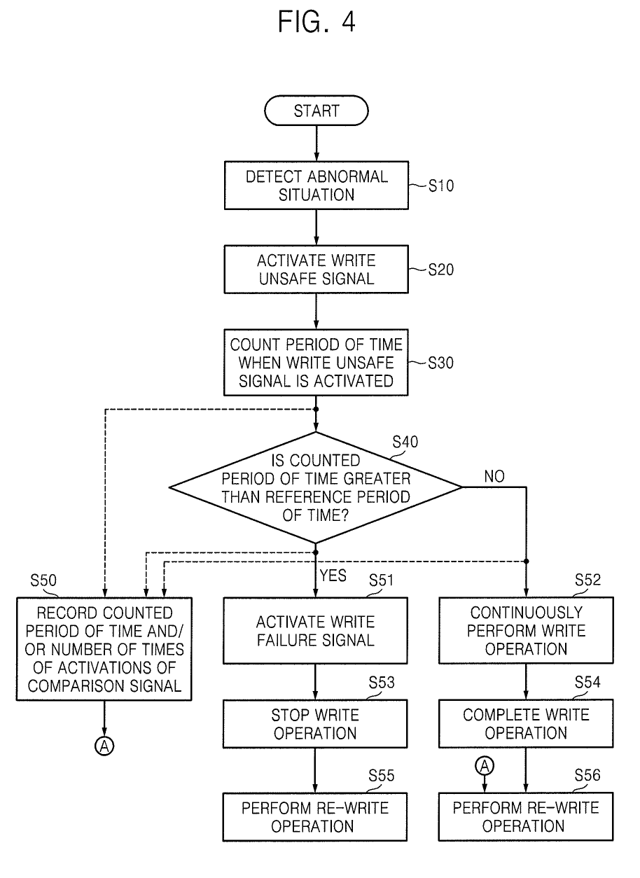

FIG. 4 is a flowchart of an operation of the disk drive 100 illustrated in FIG. 1. Referring to FIGS. 1 through 4, when an abnormal situation occurs during a write operation S10, the pre-amplifier 130 may detect the abnormal situation, activate the write unsafe signal WUS, and transmit the write unsafe signal WUS to the microcontroller 160, in operation S20.

The counter 220 may count the period of time when the write unsafe signal WUS is activated according to the clock signal and transmit the WUS count value CNT_WUS to the comparator 230 and the logger 250, in operation S30. The comparator 230 may compare the WUS count value CNT_WUS with the reference count value CNT_REF and generate the comparison signal CS corresponding to the result of the comparison, in operation S40.

If the WUS count value CNT_WUS is smaller than the reference count value CNT_REF, the disk drive 100 performs a write operation, in operation S52. Even in the case I or case II of FIG. 3, the disk drive 100 performs a write operation, in operation S52. However, as in the case III of FIG. 3, if the WUS count value CNT_WUS is greater than the reference count value CNT_REF, the failure signal generator 240 outputs the activated write failure signal WF to the processing unit 260, and thus the processing unit 260 outputs the control signals CTRL for stopping the write operation of the disk drive 100. Thus, the write operation of the disk drive 100 is stopped, in operation S53. Thereafter, the disk drive 100 may perform a re-write operation under the control of the processing unit 260, in operation S55.

The logger 250 may record at least one of the WUS count value CNT_WUS and the number of times of activations of the comparison signal CS in the memory according to LSNs, in operation S50. The operation S50 may be performed before or after the operation S40.

The write operation is completed as a result of the operation S52, in operation S54. Then, in the case I or case II, to increase the reliability of write date written to the data storage media 110, the disk drive 100 may perform a re-write operation on write data on the basis of the log data Log_DATA stored in the logger 250 under the control of the microcontroller 160, in operation S56.

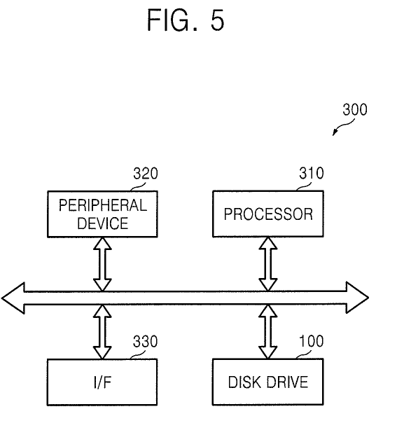

FIG. 5 is a block diagram of a data processing system 300 including the disk drive 100 illustrated in FIG. 1. The data processing system 300 may be used in computers, CCTV systems, data servers, Internet data centers, or consumer equipment (CE). The CE may be used in refrigerators, TVs, IPTVs, camcorders, home network systems, or the like. Examples of the data processing system 300 may include all kinds of systems capable of using the disk drive 100 as a data storage device.

The data processing system 300 may include the disk drive 100, a processor 310, a peripheral 320, and an interface 330.

The processor 310 may control the entire operation of the disk drive 100, and thus may be a host computer. The processor 310 may transmit and receive data to and from the disk drive 100 via a data bus. The processor 310 may output a write command and write data to the disk drive 100. Thus, the disk drive 100 may write the write data to the data storage media 110 according to the write command. If the write unsafe signal WUS is activated during the write operation, the microcontroller 160 may perform the operation described above with reference to FIGS. 1 through 4.

The peripheral 320 may be a printer, an external hard disk drive, a modem, a joystick, a Personal Video Recorder (PVR), a small computer system interface (SCSI), a mouse, a LAN card, a graphic card, a video adapter, a sound card, or a Radeon.

The interface 330 may be an input/output device for transmitting and receiving data to and from the disk drive 100 under the control of the processor 310. The interface 330 may be an example of the peripheral 320.

A controller according to an exemplary embodiment may record a generation log of a write unsafe signal. A disk drive including the controller according to an exemplary embodiment may recover data by using the generation log, thereby increasing the reliability of data. Expressions such as “at least one of,” when preceding a list of elements, modify the entire list of elements, and not the individual elements of the list.

While the present invention has been particularly shown and described with reference to exemplary embodiments thereof, it will be understood that various changes in form and details may be made therein without departing from the spirit and scope of the following claims.

What is claimed is:

1. A controller for use in a disk drive, the controller comprising:
a comparison signal generator which compares a first period of time when a write unsafe signal is output from a pre-amplifier with a second period of time to generate a comparison signal;
a write failure signal generator which generates a write failure signal according to a write gate signal and the comparison signal; and
a logger which logs, as log data, at least one of the first period of time and a number of times the comparison signal is generated.

2. The controller of claim 1, further comprising a memory which accumulatively stores the log data according to Logical Sector Numbers (LSNs).

3. A disk drive comprising:
a disk;
a head which writes a write data signal to the disk during a write operation;
an access circuit which supplies the write data signal to the head and generates a write unsafe signal according to an abnormal signal output from the head; and
a controller which generates a write failure signal for stopping the write operation performed by the head according to the write unsafe signal output from the access circuit,
wherein the controller generates the write failure signal in response to a write gate signal and a comparison signal corresponding to a result of a comparison between a first period of time when the write unsafe signal is generated and a second period of time and logs, as log data, at least one of the first period of time and a number of times the comparison signal is generated.

4. The disk drive of claim 3, wherein the controller controls write data corresponding to the write data signal to be transmitted to the access circuit so that the write data signal is re-written to the disk according to the log data.

5. The disk drive of claim 3, wherein the access circuit comprises at least one of a pre-amplifier and a read/write channel.

6. The disk drive of claim 3, further comprising a memory which accumulatively stores the log data according to Logical Sector Numbers (LSNs).

7. The disk drive of claim 3, further comprising at least one of a temperature detector which detects an internal temperature of the disk drive and a voltage detector which detects an operating voltage of the disk drive,
wherein when the write unsafe signal is generated, the controller logs, as the log data, at least one of detected internal temperature and detected operating voltage detected by the voltage detector.

8. A data processing system comprising:
a disk drive; and
a processor for controlling an operation of the disk drive,
wherein the disk drive comprises:
a disk;
a head which writes a write data signal corresponding to write data output from the processor to the disk during a write operation;
an access circuit which supplies the write data signal to the head and generates a write unsafe signal according to an abnormal signal output from the head; and
a controller which generates a write failure signal for stopping the write operation performed by the head according to the write unsafe signal output from the access circuit,
wherein the controller generates the write failure signal in response to a write gate signal and a comparison signal corresponding to a result of a comparison between a first period of time when the write unsafe signal is generated and a second period of time and logs, as log data, at least one of the first period of time and the number of times the comparison signal is generated.

9. The data processing system of claim 8, wherein the controller controls the write data to be transmitted to the access circuit so that the write data signal is re-written to the disk according to the log data.

10. The data processing system of claim 8, wherein the access circuit comprises at least one of a pre-amplifier and a read/write channel.

11. The data processing system of claim 8, further comprising a memory which accumulatively stores the log data according to Logical Sector Numbers (LSNs).

12. The data processing system of claim 8, further comprises at least one of a temperature detector which detects an internal temperature of the disk drive and a voltage detector which detects an operating voltage of the disk drive,
during the write unsafe signal is generated, the controller logs, as the log data, at least one of detected internal temperature and detected operating voltage.
